(19) United States
(12) Patent Application Publication
(10) Pub. No.: US 2007/0208117 A1
(43) Pub. Date: Sep. 6, 2007

(54) ALUMINUM FINE PARTICLE DISPERSED FILM, COMPOSITION FOR FORMING THE SAME AND METHOD OF FORMING THE SAME

(75) Inventors: Yasuo Matsuki, Tokyo (JP); Kazuo Kawaguchi, Tokyo (JP); Akiyoshi Fujii, Osaka (JP); Yuichi Saito, Osaka (JP); Yasumasa Takeuchi, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: JSR Corporation, Chuo-ku (JP); SHARP CORPORATION, Osaka-shi (JP); International Center for Materials Research, Kawasaki-shi (JP)

(21) Appl. No.: 11/681,501

(22) Filed: Mar. 2, 2007

(30) Foreign Application Priority Data
Mar. 3, 2006 (JP) 2006-058524

(51) Int. Cl. B32B 5/16; C08K 5/00

(52) U.S. Cl. 524/236; 428/323; 428/329; 428/409

(57) ABSTRACT

A composition for forming an aluminum fine particle dispersed film, which comprises a complex of an amine compound and aluminum hydride and a polymer component having film formability is prepared, and a film formed therefrom is heated or exposed to light to manufacture an aluminum fine particle dispersed film.

The above composition can provide an Al fine particle dispersed film which can be used in electronic devices or optical devices, an Al wiring pattern film and an Al mirror film.

### FIELD OF THE INVENTION

The present invention relates to a film comprising metal aluminum fine particles uniformly dispersed in a film matrix, a precursor composition for manufacturing the same and a method of forming the above film from the above precursor composition. More specifically, it relates to an aluminum fine particle dispersed film which can be advantageously used in electronic devices, optical devices, mirrors, etc., a precursor composition for forming the same and a method of forming the same.

### DESCRIPTION OF THE PRIOR ART

In the electronics package field, various methods are now employed to electrically connect connection terminals (electrodes) which are spaced apart from one another. The commonly used method of connecting the electrodes is soldering. In this case, there is a problem with the connection of connection terminals having a narrow pitch, solder wettability is required for the connection terminals, and further a heat-resistant insulating substrate is necessary because of high-temperature connection. Although the method of connecting electrodes by means of a gold wire, so-called “wire bonding method” is known, it is known that there is a limitation to the connection of fine electrodes in this case as well. As the method of connecting fine electrodes, one in which the electrodes of a bare chip LSI and the electrodes of a printed circuit board are put together to be interconnected, so-called “flip chip mounting” is employed in notebook personal computers, portable word processors and PCMCIA cards. Demand for small-sized electronic equipment is strong and even when they are made small in size, it is necessary to prevent the reduction of the function of the equipment. Since the equipment has higher functions even when it does not change in size, built-in circuit boards and LSI chips need to be made much smaller in size and the density of circuits needs to be increased. However, a connection failure, disconnection or lateral continuity readily occurs when the density of circuits is merely increased, whereby unreliability (fraction defective) at the time of manufacture and unreliability (failure rate) at the time of use become high.

To solve the above problems, there is known an electric circuit board comprising conductive fine particles or anisotropically conductive fine particles between electrodes. Further, when electrodes must be interconnected and the distance between electrode substrates must be kept constant, conductive fine particles are used for vertical continuity in the liquid crystal display device or sealing portion of a liquid crystal display. Although metal particles such as gold, silver or nickel particles are used as the conductive particles, they are not uniform in shape or have a larger specific gravity than a binder resin and may settle in a conductive paste. Therefore, it is difficult to disperse these metal particles uniformly, and accordingly, they lack connection reliability.

To form fine electrodes in order to increase the density of circuits, photolithography is commonly used. For this purpose, apparatuses such as a pattern design apparatus, exposure apparatus, developing apparatus, etching apparatus and cleaning/drying apparatus are necessary, thereby boosting equipment investment. Furthermore, even in the case of small-quantity production as in a trial stage, materials for passing raw materials through these apparatuses, that is, a pattern mask, resist, developer, etchant and washing liquid are required, and the time for manufacturing the mask and the time of passing through the steps are needed. As the product development cycle is becoming shorter, the period of development and trial manufacture is becoming shorter and the number of products is becoming smaller. Therefore, the process takes time and money, which is a problem to be solved.

Meanwhile, a metal used in the electrodes and terminals is formed by film forming techniques such as plating, deposition and sputtering. It can be said that the size of an apparatus is determined by the size of a substrate. A manufacturing apparatus is selected according to the size of a product and how many products will be made. In order to manufacture products of various sizes and cut costs, a manufacturing apparatus capable of handling the largest substrate is selected. In this case, the manufacturing apparatus capable of handling the largest substrate is expensive, waste materials in the case of trial production or small-quantity production and often takes much labor to change the type of products though it is satisfactory in terms of processing a large quantity of products of the same size and the same shape.

The inventors of the present invention have disclosed a method of forming an aluminum film by subjecting a complex of an amine compound and aluminum hydride (to be referred to as “alan.amine complex” hereinafter) as a precursor to a heat treatment and/or an optical treatment as means of forming a metal aluminum film without using a high-vacuum apparatus (refer to JP-A 2002-338891). The inventors have further conducted intensive studies on the material and have found that when the precursor of the above alan.amine complex is dispersed in a polymer, it can be easily handled and that a film having conductivity and comprising metal aluminum fine particles uniformly dispersed in a polymer matrix can be formed by subjecting the film to an optical treatment or a heat treatment to convert the precursor into metal aluminum in the polymer matrix.

### SUMMARY OF THE INVENTION

It is an object of the present invention which has been made in the view of the above situation to provide a composition for forming an aluminum fine particle dispersed film, a method of forming an aluminum fine particle dispersed film from the composition and the aluminum fine particle dispersed film. A pattern forming film and a mirror surface film (mirror) formed by the present invention can be used in electronic devices, optical devices, etc.

According to the present invention, firstly, the above object and advantage of the present invention are attained by a composition which comprises a complex of an amine compound and aluminum hydride and a resin component having film formability and is used to form an aluminum fine particle dispersed film.

According to the present invention, secondly, the above object and advantage of the present invention are attained by a method of forming an aluminum fine particle dispersed film, comprising the steps of:

forming a film from the composition; and

subjecting the film to an optical or heat treatment to form aluminum fine particles in the film.

According to the present invention, thirdly, the above object and advantage of the present invention are attained by an aluminum fine particle dispersed film manufactured by the above method.

### BRIEF DESCRIPTION OF THE DRAWINGS

FIG. 1 is a microphotograph of the film of the present invention obtained in Example 1;

FIG. 2 is a microphotograph of the film of the present invention obtained in Example 3;

FIGS. 3(a) to (d) are process diagrams showing the method of manufacturing the film of the present invention in Example 2;

FIGS. 4(a) and (b) are diagrams showing an application example of the film manufactured in Example 2 of the present invention in Example 4;

FIGS. 5(a) to (d) are diagrams showing another application example of the film of the present invention in Example 4;

FIGS. 6(a) to (e) are diagrams showing the manufacturing method and application of the film of the present invention in Example 5;

FIGS. 7(a) to (d) are diagrams showing still another application example of the film of the present invention in Example 4;

FIGS. 8(a) and (b) are diagrams showing the reaction of the film of the present invention in Example 6;

FIGS. 9(a) and (b) are diagrams showing the method of manufacturing the film of the present invention in Example 6;

FIGS. 10(a) and (b) are diagrams showing that the film of the present invention in Example 6 is mounted on an electronic part;

FIG. 11 is a diagram showing an application example of the film of the present invention in Example 7 as a mirror; and

FIG. 12 is a diagram showing another application example of the film of the present invention in Example 7 as a mirror.

### DETAILED DESCRIPTION OF THE PREFERRED EMBODIMENTS

A description is first given of the composition for forming an aluminum fine particle dispersed film used in the present invention.

The complex used in the method of the present invention is a complex of an amine compound and aluminum hydride. Aluminum hydride (often idiomatically called “alan”) is a compound composed of aluminum and hydrogen atoms and generally represented by AlH₃. The complex (to be referred to as “alan.amine complex” hereinafter) used in the present invention can be synthesized in accordance with the method disclosed by J. K. Ruff et al, J. Amer. Chem. Soc., vol. 82, pp. 2141, 1960, G. W. Fraser et al, J. Chem. Soc., pp. 3742, 1963 and J. L. Atwood et al., J. Amer. Chem. Soc., vol. 113, pp. 8183, 1991. The amine compound constituting the alan.amine complex used in the method of the present invention is a compound represented by the following formula (1):

R¹R²R³N (1)

wherein R¹, R² and R³ are each independently a hydrogen atom, alkyl group having 1 to 12 carbon atoms, alkenyl group, alkynyl group, cyclic alkyl group or aryl group.

In the formula (1), preferred examples of R¹, R² and R³ include hydrogen, saturated alkyl groups such as methyl group, ethyl group, propyl group, butyl group, pentyl group, hexyl group, heptyl group, octyl group, nonyl group, decyl group, undecyl group and dodecyl group, alkenyl groups having an unsaturated group such as methallyl group, alkynyl groups such as phenylethynyl group, cyclic alkyl groups such as cyclopropyl group, and groups having an aryl group such as phenyl group and benzyl group. These alkyl groups, alkenyl groups and alkynyl groups may be linear, cyclic or branched.

Examples of the amine compound represented by the formula (1) include ammonia, trimethylamine, triethylamine, tri-n-propylamine, tri-isopropylamine, tricyclopropylamine, tri-n-butylamine, triisobutylamine, tri-t-butylamine, tri-2-methylbutylamine, tri-n-hexylamine, tricyclohexylamine, tri(2-ethylhexyl)amine, trioctylamine, triphenylamine, tribenzylamine, dimethylphenylamine, diethylphenylamine, diisobutylphenylamine, methyldiphenylamine, ethyldiphenylamine, isobutyldiphenylamine, dimethylamine, diethylamine, di-n-propylamine diisopropylamine, dicyclopropylamine, di-n-butylamine, diisobutylamine, di-t-butylamine, methylethylamine, methylbutylamine, di-n-hexylamine, dicyclohexylamine, di(2-ethylhexyl)amine, dioctylamine, diphenylamine, dibenzylamine, methylphenylamine, ethylphenylamine, isobutylphenylamine, methylmethacrylamine, methyl(phenylethynyl)amine, phenyl(phenylethynyl)amine, methylamine, ethylamine, n-propylamine, isopropylamine, cyclopropylamine, n-butylamine, isobutylamine, t-butylamine, 2-methylbutylamine, n-hexylamine, cyclohexylamine, 2-ethylhexylamine, octylamine, phenylamine and benzylamine.

Examples of the amine compound used in the present invention include ethylenediamine, N,N′-dimethylethylenediamine, N,N′-diethylethylenediamine, N,N,N′,N′-tetramethylethylenediamine, N,N,N′,N′-tetraethylethylenediamine, N,N′-diisopropylethylenediamine, N,N′-di-t-butylethylenediamine, N,N′-diphenylethylenediamine, diethylenetriamine, 1,7-dimethyl-1,4,7-triazaheptane, 1,7-diethyl-1,4,7-triazaheptane, triethylenetetramine, phenylenediamine, N,N,N′,N′-tetramethyldiaminobenzene, 1-aza-bicyclo[2.2.1]heptane, 1-aza-bicyclo[2.2.2]octane(quinuclidine), 1-azacyclohexane, 1-aza-cyclohexan-3-ene, N-methyl-1-azacyclohexan-3-ene, morpholine, N-methylmorpholine, N-ethylmorpholine, piperazine and N,N′,N″-trimethyl-1,3,5-triaza-cyclohexane. These amine compounds may be used alone or as a mixture of two or more. The alan.amine complex is used as a composition dissolved or suspended in a medium. The concentration of the alan.amine complex in the solution is preferably 0.1 to 50 wt %. This can be suitably adjusted according to a desired film conductivity.

The polymer for forming a film used in the composition of the present invention is a polymer which is inactive to the alan.amine complex, such as a hydrocarbon-based polymer. Examples of the polymer include polystyrene, polybutadiene, polyisoprene, polymethyl pentene, polyparaphenylene, styrene-butadiene copolymer, norbornene addition polymer and norbornene ring-open polymer. These polymers maybe used in combination of two or more.

The film forming composition of the present invention is preferably used as a solution. Any solvent is acceptable if it can dissolve the above polymer and does not react with the alan.amine complex. Examples of the solvent include hydrocarbons such as n-pentane, cyclopentane, n-hexane, cyclohexane, n-heptane, cycloheptane, n-octane, cyclooctane, decane, cyclodecane, dicyclopentadiene hydride, benzene, toluene, xylene, durene, indene, tetrahydronaphthalene, decahydronaphthalene, norbornane and squalane; and ethers such as diethyl ether, dipropyl ether, dibutyl ether, ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, tetrahydrofuran, tetrahydropyran, and p-dioxane. In these, a hydrocarbon solvent or a mixture of a hydrocarbon solvent and an ether solvent is preferably used from the viewpoints of solubility and the stability of the solution. These solvents may be used alone or as a mixture of two or more.

The concentration of solid components in the composition of the present invention is preferably 0.1 to 99 wt %, more preferably 10 to 80 wt %. It can be suitably adjusted according to the thickness of a desired conductive film.

The composition of the present invention may optionally contain metal particles other than aluminum. Examples of the metal particles include metal particles such as tin, copper, silver, gold, platinum, nickel, ruthenium, palladium, iron, niobium, titanium, silicon and indium particles and/or semiconductor particles. These particles may be used alone or in combination of two or more. Commercially available metal particles may be used directly or after a surface oxide is removed by an acid or alkali. The acid or alkali for removing the surface oxide depends on the type of a metal to be surface treated. Examples of the acid and alkali which are not particularly limited include inorganic acids such as hydrochloric acid, sulfuric acid, nitric acid and hydrofluoric acid and aqueous solutions thereof, and aqueous solutions of alkali hydroxides such as sodium hydroxide and potassium hydroxide. The particle diameter of the metal particles is preferably 10 μm or less, more preferably 5 μm or less, particularly preferably 1 μm or less. The amount of the metal particles is preferably 0.01 to 100 parts by weight, more preferably 0.05 to 80 parts by weight based on 100 parts by weight of the polymer. When the amount of the metal particles is smaller than 0.01 part by weight, a film having a high density may not be obtained and when the amount is larger than 100 parts by weight, the stability of the solution may hardly be obtained. The solution of the composition for forming an aluminum fine particle dispersed film of the present invention may be suitably mixed with fine particles of a metal oxide such as zirconium oxide, titanium oxide or silicon oxide as required to control conductivity.

The process of manufacturing the composition for forming an aluminum fine particle dispersed film, which comprises an alan.amine complex, a polymer and a solvent, used in the present invention is not particularly limited. For example, the composition is prepared by adding a predetermined amount of a polymer solution to a solution of a complex of an amine compound and an aluminum hydride compound under agitation. The addition temperature is preferably 0 to 50° C., more preferably 5 to 30° C. The stirring time is preferably 0.1 to 120 minutes, more preferably 0.2 to 60 minutes.

The composition for forming an aluminum fine particle dispersed film improves the wettability of a substrate with a solution and the leveling property of the coated film and prevents the formation of irregularities on the coating film and the formation of an orange peal skin. Therefore, a small amount of a surface tension control agent such as a fluorine-based, silicone-based or nonionic surfactant may be optionally added in limits that the target function is not impaired. Examples of the nonionic surfactant which can be added include fluorine-based surfactants having an alkyl fluoride group or perfluoroalkyl group and polyether alkyl-based surfactants having an oxyalkyl group.

The above fluorine-based surfactants include C₉F₁₉CONHC₁₂H₂₅, C₈F₁₇SO₂NH— (C₂H₄O)₆H, C₉F₁₇O(Plutonic L-35) C₉F₁₇ and C₉F₁₇O(Plutonic P-84)C₉F₁₇. (Plutonic L-35: polyoxypropylene-polyoxyethylene block copolymer manufactured by ADEKA, having an average molecular weight of 1,900; Plulonic P-84: polyoxypropylene-polyoxyethylene block copolymer manufactured by ADEKA, having an average molecular weight of 4,200). Commercially available products of these fluorine-based surfactants include MEGAFACE F171 and F173 (of Dainippon Ink and Chemicals, Inc.), Asahi Guard AG710 (of Asahi Glass Co., Ltd.), Florade FC-170C, FC430 and FC431 (of Sumitomo 3M Limited), Surflon S-382, SC101, SC102, SC103, SC104, SC105 and SC106 (of Asahi Glass Co., Ltd.), BM-1000 and 1100 (of B. M-Chemie Co., Ltd.) and Schsego-Fluor (of Schwegmann Co., Ltd.).

The polyether alkyl-based surfactants include polyoxyethylene alkyl ethers, polyoxyethylene allyl ethers, polyoxyethylene alkylphenol ethers, polyoxyethylene fatty acid esters, sorbitan fatty acid esters, polyoxyethylene sorbitan fatty acid esters and oxyethylene oxypropylene block polymers. Commercially available products of these polyether alkyl-based surfactants include Emulgen 105, 430, 810 and 920, Reodol SP-40S and TW-L120, Emanol 3199 and 4110, Exel P-40S, Bridge 30, 52, 72 and 92, Arassel 20, Emasol 320, Tween 20 and 60 and Merge 45 (of Kao Corporation), and Noniball 55 (of Sanyo Chemical Industries, Ltd.). Other nonionic surfactants include polyoxyethylene fatty acid esters, polyoxyethylene sorbitan fatty acid esters and polyalkylene oxide block copolymers which are available under the trade names of Chemistat 2500 (of Sanyo Chemical Industries, Ltd.), SN-EX9228 (of Sun Nopco Co., Ltd.), and Nonal 530 (of Toho Kagaku Co., Ltd.).

The composition for forming an aluminum fine particle dispersed film obtained as described above is applied to a substrate to form a film containing an alan.amine complex. Although the material and shape of the substrate are not particularly limited, a material which can stand a heat treatment in the subsequent step is preferred, and the substrate on which the coating film is to be formed may be flat or non-flat with a level difference and is not limited to a particular shape. Specific examples of the material of the substrate include glasses, metals, plastics and ceramics. The glasses include quartz glass, boro-silicated glass, soda glass and lead glass. The metals include gold, silver, copper, nickel, silicon, aluminum, iron and stainless steel. The plastics include polyimide and polyether sulfone. The form of the material is not particularly limited and may be bulk-like, plate-like or film-like. The coating technique for applying the above solution is not particularly limited and may be spin coating, dip coating, curtain coating, roll coating, spray coating, ink jet coating or printing. The solution may be applied once or a plurality of times.

In the present invention, as the above substrate may be used a substrate having a coating film (primary coat) made of an organic metal compound which is formed by applying a solution containing the organic metal compound having a metal atom selected from the group consisting of Ti, Pd and Al. When the substrate has this primary coat, adhesion between the substrate and the aluminum film is kept stably.

Examples of the organic metal compound having a Ti atom include titanium alkoxides, titanium compounds having an amino group, titanium complexes with β-diketone, titanium compounds having a cyclopentadienyl group and titanium compounds having a halogen atom.

Examples of the organic metal compound having a Pd atom include palladium complexes having a halogen atom, palladium complexes with an acetate or β-diketone, palladium complexes with a compound having a conjugated carbonyl group, phosphine-based Pd complexes, and aluminum complexes with an aluminum alkylate or β-diketone. Examples of the organic metal compound having an Al atom include aluminum alkoxides, aluminum alkylates and aluminum complexes with β-diketone, excluding the alan.amine complex. Examples of the organic metal compound include titanium alkoxides such as titanium methoxide, titanium ethoxide, titanium-n-propoxide, titanium-n-nonyloxide, titanium stearyl oxide, titanium isopropoxide, titanium-n-butoxide, titanium isobutoxide, titanium-t-butoxide, titanium tetrakis(bis-2,2-(allyloxymethyl)butoxide, titanium triisostearoyl isopropoxide, titanium trimethylsiloxide, titanium-2-ethylhexoxide, titanium methacrylate triisopropoxide, (2-methacryloxyethoxy)triisopropoxytitanate, titanium methoxypropoxide, titanium phenoxide, titanium methylphenoxide, poly(dibutyltitanate), poly(octyleneglycoltitanate), titanium bis(triethanolamine)diisopropoxide, titanium tris(dodecylbenzenesulfonate)isopropoxide, titanium trimethacrylate methoxyethoxy ethoxide, titanium tris(dioctylpyrophosphate)isopropoxide and titanium lactate; titanium compounds having an amino group such as tetrakis(dimethylamino)titanium and tetrakis(diethylamino)titanium; titanium complexes with β-diketone such as titanium bis(ethylacetoacetate)diisopropoxide, tris(2,2,6,6-tetramethyl-3,5-heptanedionate)titanium, titanium oxidebis(pentanedionate), titanium oxide(tetramethylheptanedionate), titanium methacryloxy acetoacetate triisopropoxide, titanium di-n-butoxide(bis-2,4-pentanedionate), titanium diisopropoxide(bis-2,4-pentanedionate), titanium diisopropoxide bis(tetramethylheptanedionate), titanium diisopropoxide bis(ethylacetoacetate), di(iso-propoxide)bis(2,2,6,6-tetramethyl-3,5-heptanedionate)titanium and titanium allylacetoacetate triisopropoxide; titanium compounds having a cyclopentadienyl group such as titanocene dichloride, (trimethyl)pentamethyl cyclopentadienyl titanium and dimethylbis(t-butylcyclopentadienyl)titanium; titanium compounds having a halogen atom such as indenyl titanium trichloride, pentamethylcyclopentadienyl titanium trichloride, pentamethylcyclopentadienyl titanium trimethoxide, trichlorotris(tetrahydrofuran)titanate, tetrachlorobis(tetrahydrofuran)titanium, titanium chloride triisopropoxide, titanium iodide triisopropoxide, titanium dichloride diethoxide, dichlorobis(2,2,6,6-tetramethyl-3,5-heptanedionate) titanium, tetrachlorobis(cyclohexylmercapto)titanium and titanium chloride; palladium complexes having a halogen atom such as palladium chloride, allyl palladium chloride, dichlorobis(acetonitrile)palladium and dichlorobis(benzonitrile)palladium; acetates such as palladium acetate; palladium complexes with β-diketone such as palladium 2,4-pentanedionate and palladium hexafluoropentanedionate; palladium complexes with a compound having a conjugated carbonyl group such as bis(dibenzylideneacetone)palladium; phosphine-based Pd complexes such as bis[1,2-bis(diphenylphosphino)ethane]palladium, bis(triphenylphosphine)palladium chloride, bis(triphenylphosphine)palladium acetate, diacetate bis(triphenylphosphine)palladium, dichloro[1,2-bis(diphenylphosphine)ethane]palladium, trans-dichlorobis(tricyclohexylphosphine)palladium, trans-dichlorobis(triphenylphosphine)palladium, trans-dichlorobis(tri-o-tolylphosphine)palladium and tetrakis(triphenylphosphine) palladium; aluminum alkoxides such as aluminum ethoxide, aluminum isopropoxide, aluminum-n-butoxide, aluminum-s-butoxide, aluminum-t-butoxide, aluminum ethoxyethoxyethoxide, aluminum phenoxide and aluminum lactate; aluminum alkylates such as aluminum acetate, aluminum acrylate, aluminum methacrylate and aluminum cyclohexane butyrate; and aluminum complexes with β-diketone such as aluminum-2,4-pentanedionate, aluminum hexafluoropentanedionate, aluminum-2,2,6,6-tetramethyl-3,5-heptanedionate, aluminum-s-butoxide bis(ethylacetoacetate), aluminum di-s-butoxide ethylacetoacetate and aluminum diisopropoxide ethylacetoacetate.

In these, titanium isopropoxide, aluminum isopropoxide, titanium bis(ethylacetoacetate)diisopropoxide, palladium-2,4-pentanedionate, palladium hexafluoropentanedionate, aluminum-2,4-pentanedionate and aluminum hexafluoropentanedionate are preferred.

Any solvent may be used as the solvent used in the solution of the organic metal compound having a metal atom selected from the group consisting of Ti, Pd and Al if it can dissolve the organic metal compound by itself or as a mixed solvent with water. Examples of the solvent include water, tetrahydrofuran, dioxane, ethers such as ethylene glycol dimethyl ether, ethylene glycol diethyl ether, diethylene glycol dimethyl ether and diethylene glycol diethyl ether, alcohols such as methanol, ethanol and propanol, and aprotic polar solvents such as N-methylpyrrolidone, N,N-dimethylformamide, N,N-dimethylacetamide, hexamethylphosphoramide and γ-butyrolactone. These solvents may be used alone or as a mixed solvent with water.

The solution of the organic metal compound may be applied to the substrate in the same manner as the method of applying the polymer solution containing the alan.amine complex. The thickness of the coating film (primary coat) is preferably 0.001 to 10 μm, more preferably 0.005 to 1 μm after the solvent is removed. When the coating film is too thick, the flatness of the film is hardly obtained and when the coating film is too thin, its adhesion to the substrate or a film in contact may deteriorate. The primary coat is formed by applying the above solution, drying it and removing the solvent.

In the present invention, the polymer film obtained by applying the polymer solution containing the alan.amine complex is heated and/or exposed to light to convert the alan.amine complex into metal aluminum fine particles. The temperature of the heat treatment is preferably 40° C. or higher, more preferably 70 to 150° C. The heating time is 30 seconds to 120 minutes. The atmosphere for the heat treatment or baking is preferably a hydrogen atmosphere containing as little oxygen as possible, with result that a high-quality conductive film can be obtained. As hydrogen in the above baking atmosphere may be used a mixed gas of hydrogen and nitrogen, helium or argon. An aluminum film can also be formed by exposing a coating film formed by applying the solution containing the alan.amine complex to light. For this exposure, a low-pressure or high-pressure mercury lamp, deuterium lamp, rare gas discharge light such as argon, krypton or xenon, YAG laser, argon laser, carbon dioxide gas laser or excimer laser such as XeF, XeCl, XeBr, KrF, KrCl, ArF or ArCl may be used as a light source. These light sources have an output of 10 to 5,000 W. For example, 100 to 1,000 W suffices. The wavelength of these light sources is not particularly limited. It is, for example, 170 to 600 nm. Use of a laser beam is particularly preferred from the viewpoint of modifying the quality of the conductive film. The temperature at the time of exposure is, for example, room temperature to 200° C. A mask may be used to expose only a specific portion. The preferred thickness of the conductive film which differs according to the coating technique and the concentration of the solid components is preferably 0.01 to 100 μm, more preferably 0.05 to 10 μm. When the film is too thick, the flatness of the film is hardly obtained and when it is too thin, its adhesion to the substrate or a film in contact may deteriorate.

The aluminum fine particle dispersed film obtained as described above is preferably subjected to a heat treatment after the above step. The heat treatment can improve the density of the film and the electric properties of the film.

The heat treatment temperature is preferably 100° C. or higher, more preferably 150 to 500° C. The heating time is 30 seconds to 120 minutes.

As described above, according to the present invention, a film is formed from the solution containing the alan.amine complex which can be converted into metal aluminum and dispersed in a polymer and then subjected to an optical and/or heat treatment so as to form metal aluminum in the polymer matrix, thereby making it possible to form a stable film in which aluminum exists in the form of fine particles, provide conductivity and make a mirror surface. Consequently, an Al fine particle dispersed film, an Al wiring pattern film and an Al mirror film can be manufactured. They can be used in electronic devices or optical devices, an Al film can be formed without using a vacuum apparatus, an Al film having a curved surface or complex shape which cannot be formed by vacuum film formation can be formed, wiring can be easily formed by processing an Al film without using a chemical, huge investment in equipment is eliminated, and small-quantity production becomes easy. Therefore, the waste of materials is avoided, an environmental load is reduced, and costs can be cut.

### EXAMPLES

The following examples are provided for the purpose of further illustrating the present invention but are in no way to be taken as limiting.

### Synthesis Example 1 (Synthesis Example of alan.amine Complex)

A diethyl ether solution (100 ml) containing 20 g of triethylamine was reacted with a hydrogen chloride gas in a molar amount 5 times larger than that of triethylamine by bubbling, and the precipitated salt was filtered with a filter, washed with 100 ml of diethyl ether and dried to synthesize 24 g of triethylamine hydrochloride. 14 g of the obtained triethylamine hydrochloride was dissolved in 500 ml of tetrahydrofuran, and the resulting solution was added dropwise to 3.8 g of lithium aluminum hydride and 500 ml of a suspension of ethyl ether in a nitrogen atmosphere at room temperature over 1 hour. After the end of addition, the reaction was further continued at room temperature for 6 hours. The reaction solution was filtered with a 0.2 μm membrane filter, the filtrate was concentrated under reduced pressure in a nitrogen atmosphere, and a salt which separated out during concentration was separated by filtration with a 0.2 μm membrane filter. After the addition of 300 ml of toluene, the solvent was scattered in a nitrogen atmosphere, the solution was concentrated under reduced pressure, the salt which separated out during concentration was purified by filtration with a 0.2 μm membrane filter again, and pressure reduction was continued until toluene did not distill out any more to obtain a liquid alan.amine complex.

### Synthesis Example 2 (Synthesis Example of Polymer for Forming a Film)

750 mmols (70.5 g) of bicyclo[2.2.1]hept-2-ene, 475 mmols (63.6 g) of tricyclo[4.3.0.1^{2.5}]deca-3-ene having an endo content of 95% and 25 mmols (6.4 g) of 5-triethoxysilyl-bicyclo[2.2.1]hept-2-ene as monomers, 562 g of cyclohexane and 141 g of methylene chloride as solvents and 15.0 mmols of styrene as a molecular weight control agent were fed to a 2,000 ml reactor in a nitrogen atmosphere. A hexane solution of nickel octanoate was reacted with antimony hexafluoride in a molar ratio of 1:1 at −10° C., the by-produced precipitated Ni(SbF₆)₂ was removed, and a antimony hexafluoride modified product of nickel octanoate diluted with a toluene solution as 0.25 mmol of nitrogen atom, 2.50 mmols of methyl aluminoxane and 0.75 mmol of boron trifluoride diethyl etherate were charged to carry out polymerization. The polymerization was carried out at 25° C. for 3 hours and terminated with methanol. The conversion of the monomers into a copolymer was 90%. 660 ml of water and 47.5 mmols of lactic acid were added to the copolymer solution, stirred, mixed and reacted with a catalytic component, and water was separated from the copolymer solution by standing. A copolymer solution from which a water phase containing the reaction product of the catalytic component had been removed was added to 3 liters of isopropyl alcohol to coagulate the copolymer, and unreacted monomers and the residual catalyst were removed. The coagulated copolymer was dried to obtain a copolymer A. It was found from the gas chromatography of the unreacted monomers contained in the copolymer solution that the amount of a structural unit derived from tricyclo[4.3.0.1^{2.5}]deca-3-ene contained in the copolymer A was 35 mol %. The amount of a structural unit derived from 5-triethoxysilyl-bicyclo[2.2.1]hept-2-ene was 2.0 mol %. The copolymer A had a number average molecular weight (Mn) in terms of polystyrene of 142,000, a weight average molecular weight (Mw) of 284,000 and an Mw/Mn of 2.0. The copolymer A had a glass transition temperature of 390° C.

10 g of the copolymer A was dissolved in a mixed solvent of 45 ml of cyclohexane and 5 ml of n-heptane, 0.6 part by weight based on 100 parts by weight of the polymer of pentaerythrityl-tetrakis[3-(3,5-di-t-butyl-4-hydroxyphenyl)propionate] and 0.6 part by weight of tris(2,4-di-t-butylphenyl)phosphite as antioxidants and 0.05 part by weight based on 100 parts by weight of the polymer of tributyl phosphite as a crosslinking agent were added. This polymer solution was filtered with a membrane filter having an opening diameter of 10 μm to remove foreign matter so as to prepare a coating agent. This coating agent was cast and crosslinked with 150° C. steam, and the solvent was removed by methylene chloride to obtain a 150 μm-thick film. It had a tensile strength of 43 MPa and an elongation of 7.8%.

### Example 1

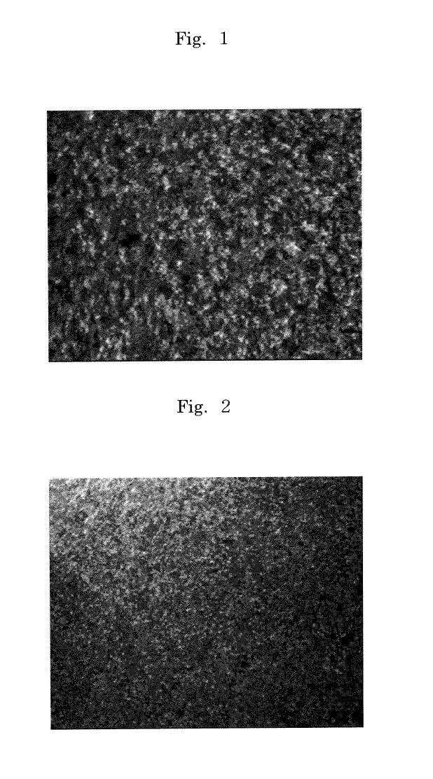

10 g of the alan.amine complex synthesized by the method of Synthesis Example 1 was dissolved in a solution containing 20 g of polystyrene having a weight average molecular weight of 50,000 dissolved in 90 g of toluene to prepare a composition for forming a film which was then applied to a glass substrate with an applicator. The coating film was placed in a hot air drier heated at 50° C. to remove the solvent and removed from the substrate to form a polystyrene film containing an achromatic transparent alan.amine complex dispersed therein. This film had a thickness of 10 μm. When its sheet resistance was measured, it was a high insulator with a resistance of 10 MΩ/□ or more. When this film was heated on a hot plate at 150° C., the film turned gray. When the sheet resistance of the film after the heat treatment was measured, it was 95 KΩ/□. When this film was observed through a microscope, aluminum fine particles were uniformly dispersed in the film as shown in FIG. 1.

### Example 2

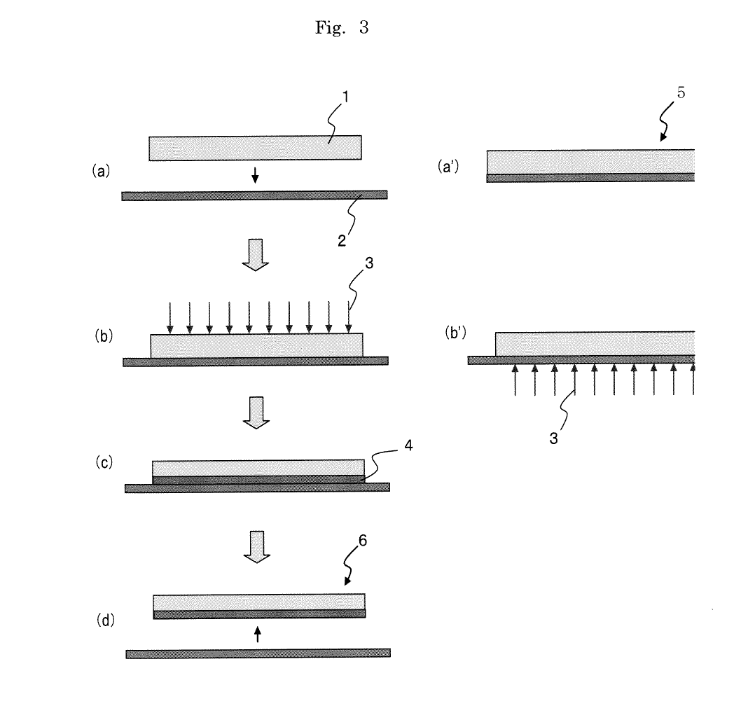

A composition for forming a film was prepared in the same manner as in Example 1 except that 1,2-polybutadiene (RB830 of JSR Corporation) was used in place of polystyrene. FIGS. 3(a) to 3(d) show the process for manufacturing a film from the composition. A glass substrate to which this composition 1 for forming a film was to be applied was immersed in a 1% toluene solution of titanium bis(ethylacetoacetate)diisopropoxide for 1 hour and dried at 100° C. for 30 minutes and at 300° C. for 30 minutes to manufacture a hydrophilic substrate 2. A 100 μm-thick film was formed on this substrate 2 with an applicator (FIG. 3(a)). Thereafter, this laminate was heated on a hot plate at 150° C. from the film side for 10 minutes (FIG. 3(b)) or the substrate side (FIG. 3(b′)) for 10 minutes. A reaction proceeded first on the glass substrate side, that is, at the titanium treated interface by this heating 3, and an Al film 4 separated out (FIG. 3(c)). When this film was removed from the glass substrate (FIG. 3(d)), it was confirmed that aluminum gathered at the interface between the polymer and the glass substrate and firmly stack to the polymer film, and a film 6 having the mirror surface of the aluminum film could be formed. The aluminum film had a resistivity of 6 μΩcm and a reflectance of 84% which means that it was satisfactory in terms of conductivity and reflectance. Although titanium bis(ethylacetoacetate)diisopropoxide was applied to the glass substrate in advance in this example, a film 5 to which titanium bis(ethylacetoacetate)diisopropoxide was applied or in which titanium bis(ethylacetoacetate)diisopropoxide was dispersed may be laminated as shown in FIG. 3(a′).

### Example 3

A composition for forming a film was prepared in the same manner as in Example 1 except that the addition polymerization polymer of norbornene obtained in Synthesis Example 2 was used in place of polystyrene. This solution was applied to a stainless steel substrate which was coated with Teflon® to form a polymer film containing an alan.amine complex. When the sheet resistance of the film was measured after the film was removed, it was 10 KΩ/□ or more. When this was heated at 250° C. for 30 minutes, it showed a sheet resistance of 14 KΩ/□. The aluminum fine particle dispersed polymer film after this heat treatment was observed through a microscope. The result is shown in FIG. 2. It is seen that aluminum fine particles are uniformly dispersed in the film.

### Example 4

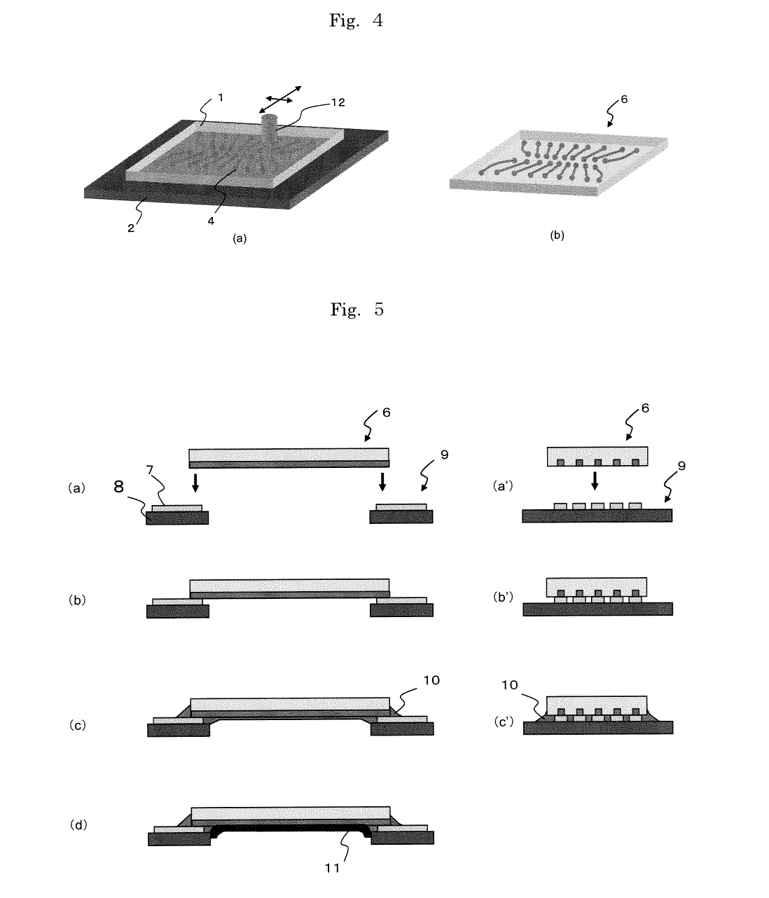

FIGS. 4(a) and 4(b) show an application example of the film manufactured in Example 2. The composition 1 for forming a film (FIG. 4(a)) was applied to the substrate 2 (FIG. 4(a)) treated with titanium like Example 2 and illuminated by a laser 12 (YAG laser, output of 100 mW, beam width of 2.5 mm) from above to induce a reaction so as to precipitate Al 4. Thereafter, the coating film was removed from the titanium bis(ethylacetoacetate)diisopropoxide formed rear surface of the substrate to obtain a film 6 having an Al pattern (FIG. 4(b)). The width of the obtained wiring was 200 μm.

While the reaction was induced by laser application in this example, wiring can be drawn with a thermal printer or by thermally pressure contacting a wiring pattern. For example, as the heating unit of the thermal printer can heat up to 200° C. or higher at the time of printing, it is used for the substrate in which a reaction proceeds at about 150° C. to precipitate Al. The width of the formed wiring is not limited to the above value in this example.

FIGS. 5(a) to 5(d) show an example in which the film 6 having wiring was connected. FIG. 5(a) shows that the film 6 having wiring was connected to a substrate 9 having wiring 7 on a glass epoxy substrate 8. The wiring 7 on the glass epoxy substrate 8 consisted of nickel and gold plating layers formed on a copper foil.

FIG. 5(a′) is a view when FIG. 5(a) is seen from another angle. The terminals of the wiring film had a pitch of 2 mm and a width of 500 μm. Terminals having a width of 800 μm were formed on the glass epoxy substrate at the same pitch. The size of the wiring is not limited to this.

After the wiring film 6 was positioned, pressure was applied to the glass epoxy substrate to bring it into contact with the wiring film 6 (FIGS. 5(b) and 5(b′)) and fixed with a silicone resin 10. For fixing, the resin was cured at room temperature (FIGS. 5(c) and 5(c′)). Since the Al wiring was exposed to the rear side of the wiring film, the same silicon resin was used to protect the wiring. This adhesion is not limited to this, and an epoxy resin maybe used or a protective film 11 such as a TAC film may be put on the wiring portion (FIG. 5(d)).

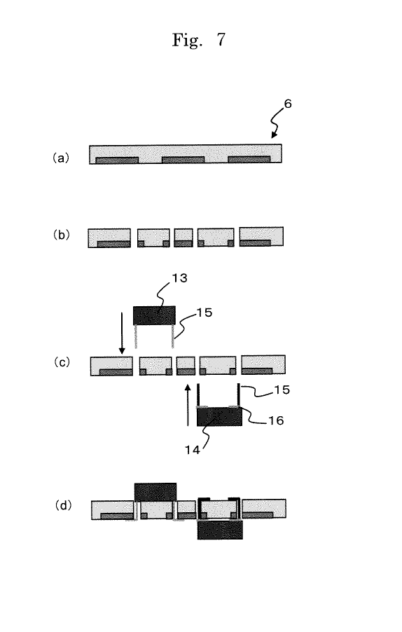

Electronic parts may be mounted on the film having a wiring pattern as follows. FIG. 7(a) shows the film 6 having precipitated Al wiring. Holes for terminals were made in the film 6 by punching at positions where electronic parts (resistors, capacitors, IC's, etc.) were to be mounted as shown in FIG. 7(b). Then, electronic parts 13 and 14 were fixed on the top surface and the rear surface by inserting lead terminals 15 into the holes (FIG. 7(c)) and caulking the leads (FIG. 7(d)). At this point, electric connection was effected by contacting the leads of the electronic part 13 with wiring portions directly. Connection portions 16 were formed on the rear surface of the electronic part 14 and could be electrically contacted with the wiring.

### Example 5

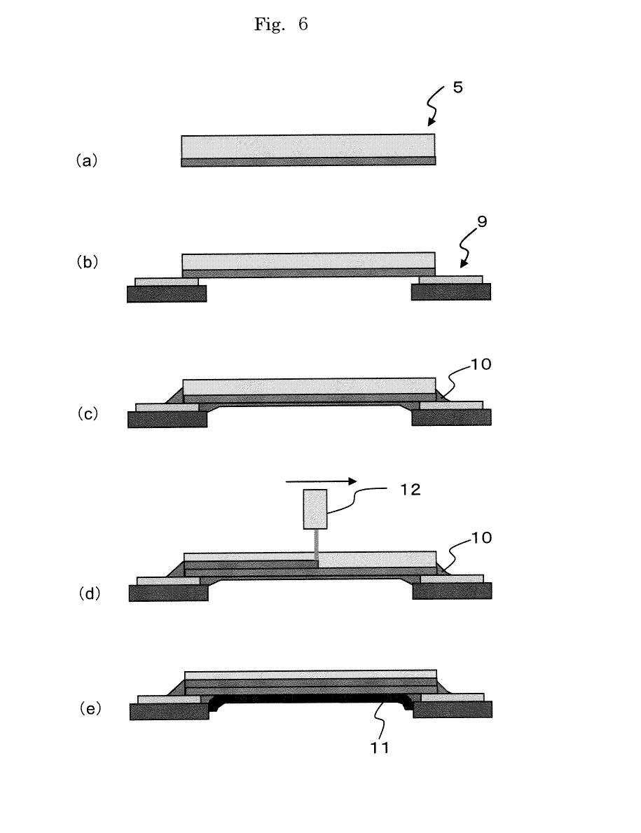

The film 5 for forming wiring therein, comprising titanium bis(ethylacetoacetate) diisopropoxide (FIG. 6(a)) can also be prepared by forming a wiring pattern after the film 5 is bonded to the glass epoxy substrate 9 (FIG. 6(b)). FIGS. 6(a) to 6(e) show that wiring was formed after the film for forming wiring therein was bonded.

After the film 5 for forming wiring therein, comprising titanium bis(ethylacetoacetate)diisopropoxide, was bonded to the glass epoxy substrate 9 with the silicone resin 10 (FIG. 6(c)), when it was exposed to a laser beam or heated by scanning a thermal head, a reaction proceeded and Al was precipitated only in a heated portion (FIG. 6(d)). Since wiring is formed later in this case, when the film for forming wiring therein is bonded to the glass epoxy substrate, special alignment between the pattern on the glass epoxy substrate side and the pattern of the wiring film is not necessary. This is because wiring formation should be carried out by scanning the laser or the thermal head while the pattern on the glass epoxy substrate side is checked.

The film 11 for protection or reinforcement may be put as shown in FIG. 6(e). This is explained in FIG. 5. Although the film 11 for protection or reinforcement is put later in this example, it is needless of say that it may be put on the film 5 for forming wiring therein (FIG. 6(a)) in advance, comprising the composition 1 for forming a film (FIG. 4(a)) and titanium bis(ethylacetoacetate)diisopropoxide.

### Example 6

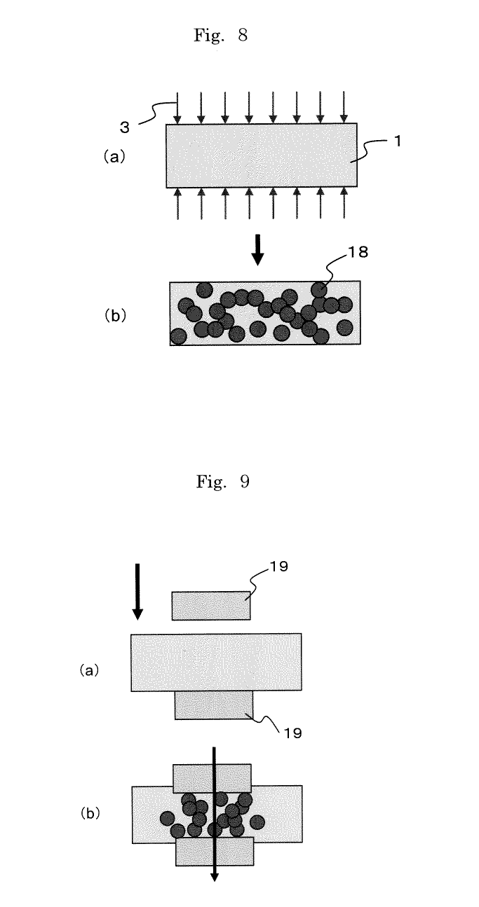

Another example to which the present invention is applied will be described with reference to FIGS. 8, 9 and 10. FIGS. 8(a) and 8(b) are diagrams showing the reaction of the film for forming wiring of the present invention.

Al 18 was precipitated from the alan.amine complex by applying heat 3 to the polystyrene film, polybutadiene film and norbornene addition polymerization film 1 containing an achromatic transparent alan.amine complex dispersed therein disclosed in Examples 1, 2 and 3 (FIG. 8(b)). Since Al precipitated as in Example 1 was dispersed in the film, when resistance was considered from the viewpoint of a conductor, its resistance value was high. Then, Al was precipitated by applying heat to the film by sandwiching it between heating units 19 from both sides as shown in FIG. 9(a). Since the alan.amine complex was distributed uniformly in the film, the precipitation density of Al was the same. However, when pressure was applied simultaneously with heat, Al was precipitated only in the sandwiched portion. Further, the density of the precipitated Al increased seemingly and the conductivity improved as the thickness of the film became small and the film was sandwiched by pressure though the amount of the precipitated Al remained the same (FIG. 9(b)).

When the film was sandwiched between metal pieces having a width of 2.0 mm from above and below and heated at 150° C. for 5 minutes, the sheet resistance of the film became 680 Ω/□, thereby improving conductivity.

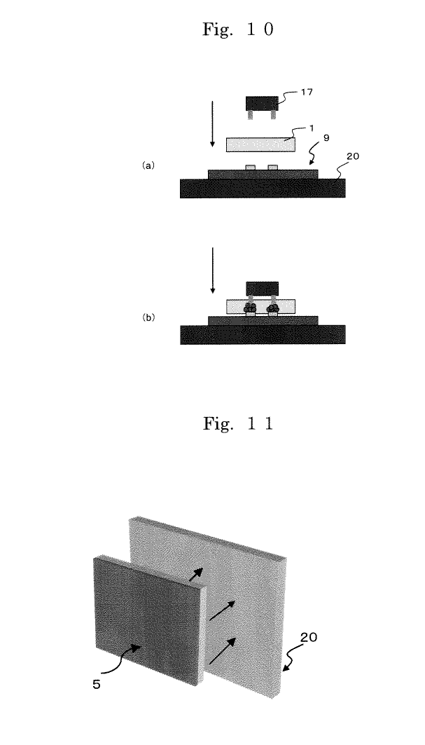

Electronic parts can be mounted by means of the film using the above technique. FIG. 10(a) shows that the glass epoxy substrate 9 was placed on a substrate 20, an electronic part 17 having exposed connection terminals was positioned with respect to the substrate 9 with the film 1 for forming wiring therein of the present invention interposed therebetween, and heat was applied to the electronic part 17 while it was pressed (FIG. 10(b)). At this point, heat was applied from the electronic part side (not shown). This is aimed to apply heat only to the terminals. When the substrate 20 is heated, heat is applied to the whole substrate 9, not only the terminals but also the whole film for forming wiring therein become reactive, and a short-circuit occurs between the terminals.

Thereafter, an adhesive was cast to fix the substrates, the film and the electronic part.

### Example 7

Another example in which the film of the present invention was used will be explained. As understood from the fact that the Al film formed in Example 2 had a low resistance of 6 μΩ·cm, it had a sufficiently high Al density and a mirror surface. Therefore, it can be used as a reflection film. FIG. 11 shows this example. The film 5 containing the alan.amine complex assembled with the film containing titanium bis(ethylacetoacetate)diisopropoxide was bonded to the substrate 20 by an epoxy adhesive and heated at 150° C. for 5 minutes to form an Al film as a mirror. The substrate may be flat or curved.

Since titanium bis(ethylacetoacetate)diisopropoxide contains TiO₂ therein, the film is hardly stained due to the optical catalytic function of TiO₂. Therefore, this mirror is hardly stained even when it is installed outdoors because titanium bis(ethylacetoacetate)diisopropoxide comes up to the surface. Since the film 6 is almost transparent before a reaction, when it is put on the substrate, the position of the substrate and an alignment mark are easily visible, thereby making it possible to easily assemble them together. Since the Al film is formed only in the heated portion, only a necessary portion can be made a mirror.

Further, the thickness of the formed film can be controlled by reducing the application time. For example, when the film is heated at 150° C. for 1 minute, a translucent film having a thickness of about 150 Å can be formed.

It is needless to say that when titanium bis(ethylacetoacetate)diisopropoxide is formed on a glass substrate, and the film of the present invention is bonded to the substrate and heated to form an Al film, a mirror can be easily manufactured. Since titanium bis(ethylacetoacetate) diisopropoxide does not come up to the surface in this case, a self-purification effect by an optical catalyst is not obtained.

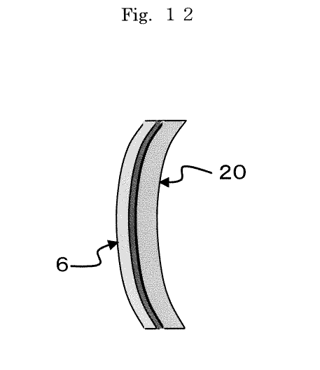

It is needless to say that the film having a mirror surface Al film 6 removed from the substrate of Example 2 may be bonded to a transparent substrate by a UV resin to manufacture a mirror. This example is shown in FIG. 12. In FIG. 12, the film is bonded to a substrate 20 having a convex surface. The substrate may be made of a metal, resin, etc.

What is claimed is:

1. A composition which comprises a complex of an amine compound and aluminum hydride and a polymer component having film formability and is used to form an aluminum fine particle dispersed film.

2. The composition according to claim 1, wherein the polymer component is a hydrocarbon-based polymer which does not react with the complex of an amine compound and aluminum hydride.

3. A method of forming an aluminum fine particle dispersed film, comprising the steps of:
forming a film from the composition of claim 1; and
exposing the film to light and/or heating it to form aluminum fine particles in the film.

4. The method according to claim 3, wherein film formation is carried out on a substrate and the substrate has a coating film of an organic metal compound having a metal atom selected from the group consisting of Ti, Pd and Al on the film forming surface.

5. An aluminum fine particle dispersed film formed by the method of claim 3 or 4.

6. The aluminum fine particle dispersed film according to claim 5, wherein the aluminum fine particles have an particle diameter of 1 μm or less.

7. The aluminum fine particle dispersed film according to claim 5, wherein the surface of the film is an aluminum mirror surface.

8. The aluminum fine particle dispersed film according to claim 7 which is conductive.
